(19) United States
(12) Patent Application Publication
(10) Pub. No.: US 2017/0202072 A1
(43) Pub. Date: Jul. 13, 2017

(54) LIGHTING APPARATUS

(71) Applicant: SILICON WORKS CO., LTD., Daejeon-si (KR)

(72) Inventors: Yong Geun KIM, Suwon-si (KR); Gyeong Sik Mun, Sejong-si (KR); Geon Soo Jang, Daejeon-si (KR)

(73) Assignee: SILICON WORKS CO., LTD., Daejeon-si (KR)

(21) Appl. No.: 15/392,499

(22) Filed: Dec. 28, 2016

(30) Foreign Application Priority Data
Jan. 13, 2016 (KR) 10-2016-0004428

(51) Int. Cl. H05B 33/08

(52) U.S. Cl. CPC H05B 33/0887; H05B 33/0815; H05B 33/0842

(57) ABSTRACT

Disclosed is a lighting apparatus using an LED as a light source. The lighting apparatus may include: a first driver configured to control a flow of a first current through a low-power switching element by comparing a reference voltage and a sensing voltage, in response to light emission of an LED group; and a second driver configured to form a flow of a second current through a high-power switching element in connection with the flow of the first current of the first driver, in response to light emission of the LED group. The lighting apparatus stably provides a current path for a current corresponding to high power.

### BACKGROUND

1. Technical Field

The present disclosure relates to a lighting apparatus, and more particularly, to a lighting apparatus using an LED as a light source.

2. Related Art

A lighting apparatus is designed to use a light source which exhibits high light emission efficiency while using a small amount of energy, in order to reduce energy consumption. Representative examples of the light source used in the lighting apparatus may include an LED. The LED is differentiated from other light sources in terms of various aspects such as energy consumption, lifetime, and light quality.

However, since the LED is driven by a current, a lighting apparatus using the LED as a light source requires a large number of additional circuits for current driving.

In order to solve the above-described problem, an AC direct-type lighting apparatus has been developed.

The AC-direct type lighting apparatus is configured to convert an AC voltage into a rectified voltage, and drive a current using the rectified voltage such that the LED emits light. Since the AC direct-type lighting apparatus directly uses a rectified voltage without using an inductor and capacitor, the AC direct-type lighting apparatus has a satisfactory power factor. The rectified voltage indicates a voltage obtained by full-wave rectifying an AC voltage.

The AC direct-type lighting apparatus includes one or more LED groups, and each of the LED groups includes one or more LEDs and emits light in response to a change of the rectified voltage.

The AC direct-type lighting apparatus includes a driving circuit which provides a current path corresponding to light emission of an LED group, and regulates a driving current.

When the lighting apparatus includes a plurality of LED groups, the plurality of LED groups sequentially emit light in response to changes of the rectified voltage, and the driving circuit provides current paths for the sequential light emissions.

The driving circuit is manufactured as one chip, and configured to perform the current path formation and the driving current regulation in the chip.

The lighting apparatus may be configured to be driven by low power or high power, depending on the use thereof. When the lighting apparatus is configured to be driven by high power, a high rectified voltage is applied to an LED group to emit light, and a large amount of driving current is passed through the current path of the driving circuit.

The driving circuit manufactured as a chip is vulnerable to heat generation. Thus, when a large amount of driving current is passed by a high rectified voltage corresponding to high power, the driving circuit may be damaged or malfunction due to the heat generation.

In order to drive the lighting apparatus to high power, a plurality of low-power driving circuits must be arranged in parallel to handle the high power. In general, the driving circuit includes a complex and important control circuit embedded therein. When the plurality of driving circuits are used, there are difficulties in designing a large number of driving circuits connected in parallel on a substrate, while the cost of the lighting apparatus is increased.

Therefore, the lighting apparatus driven by high power needs to reduce the number of driving circuits having a complex control function, and a separate circuit for high-power operation needs to be designed in connection with the driving circuits of which the number is reduced.

### SUMMARY

Various embodiments are directed to a lighting apparatus capable of providing a current path for a current corresponding to high power, and removing heat generation caused by high power.

Also, various embodiments are directed to a lighting apparatus capable of providing a current path for a first current corresponding to low power and a current path for a second current corresponding to high power, and stably forming a second current flow in connection with a first current flow.

Also, various embodiments are directed to a lighting apparatus capable of forming a current path for a current corresponding to high power, and controlling a current of a current path corresponding to low power or regulating the current of the current path corresponding to high power, thereby guaranteeing a stable current flow for light emission.

In an embodiment, a lighting apparatus may include: an LED group configured to emit light in response to a rectified voltage; a first driver including a first switching element, and configured to control a flow of a first current through the first switching element, the first current being outputted from the LED group emitting light; a second driver including a second switching element, and configured to control a flow of a second current through the second switching element in connection with the flow of the first current of the first driver, the second current being outputted from the LED group emitting light; and a sensing resistor configured to provide a common current path for the first and second currents, and provide a sensing voltage obtained by sensing a driving current flowing through the common current path. The first driver may control the flow of the first current by comparing a reference voltage and the sensing voltage.

In an embodiment, a lighting apparatus may include: a lighting unit including LED groups that sequentially emit light in response to a rectified voltage; a first driver configured to compare a reference voltage and a sensing voltage, sequentially provide a first current path corresponding to light emissions of the LED groups, and control a flow of a first current in the first current path; a second driver configured to provide a second current path in parallel to the first current path to a specific LED group in which the first current path is formed, among the LED groups, and form a flow of a second current in the second current path in connection with the flow of the first current; and a sensing resistor configured to provide a common current path for the first and second currents, and provide a sensing voltage obtained by sensing a driving current flowing through the common current path, wherein the first driver controls the flow of the first current by comparing the reference voltage and the sensing voltage.

In an embodiment, a lighting apparatus may include: a lighting unit including LED groups that sequentially emit light in response to a rectified voltage; a first driver configured to compare a reference voltage and a first sensing voltage, sequentially provide a first current path corresponding to light emissions of the LED groups, and control a flow of a first current in the first current path; a second driver configured to provide a second current path in parallel to the first current path to a specific LED group in which the first current path is formed, among the LED groups, and form a flow of a second current in the second current path in connection with the flow of the first current; a first sensing resistor configured to provide a first sensing voltage obtained by sensing the first current of the first current path; and a second sensing resistor through which the second current of the second current path flows.

### BRIEF DESCRIPTION OF THE DRAWINGS

FIG. 1 is a block diagram illustrating a lighting apparatus according to an embodiment of the present invention.

FIG. 2 is a circuit diagram illustrating a first driver of FIG. 1.

FIG. 3 is a circuit diagram illustrating a second driver of FIG. 1.

FIG. 4 is a waveform diagram according to the embodiment of FIG. 1.

FIG. 5 is a block diagram illustrating a lighting apparatus according to another embodiment of the present invention.

FIG. 6 is a block diagram illustrating a lighting apparatus according to still another embodiment of the present invention.

FIG. 7 is a circuit diagram illustrating a second driver of FIG. 6.

FIG. 8 is a block diagram illustrating a lighting apparatus according to still another embodiment of the present invention.

FIG. 9 is a circuit diagram illustrating a part of a second driver of FIG. 8.

### DETAILED DESCRIPTION

Hereafter, embodiments of the present invention will be described in detail with reference to the accompanying drawings. The terms used in the present specification and claims are not limited to typical dictionary definitions, but must be interpreted into meanings and concepts which coincide with the technical idea of the present invention.

Embodiments described in the present specification and configurations illustrated in the drawings are preferred embodiments of the present invention, and do not represent the entire technical idea of the present invention. Thus, various equivalents and modifications capable of replacing the embodiments and configurations may be provided at the point of time that the present application is filed.

A lighting apparatus according to an embodiment of the present invention is configured to provide a current path for a current by high power through a separate driver.

The driver is divided into a first driver 300 and a second driver 400. The first driver 300 is a driving circuit for low power and embodied by a semiconductor chip, and the second driver 400 provides a current path for a current by high power, separately from the first driver.

The second driver 400 is configured to form a current path in response to a high rectified voltage Vrec, and stably form a current flow of the current path formed therein in connection with a current flowing to the first driver 300.

Hereafter, the current path and the current of the first driver are referred to as a first current path and a first current, and the current path and the current of the second driver are referred to as a second current path and a second current. The first current is controlled to an amount equal to or less than the amount of second current.

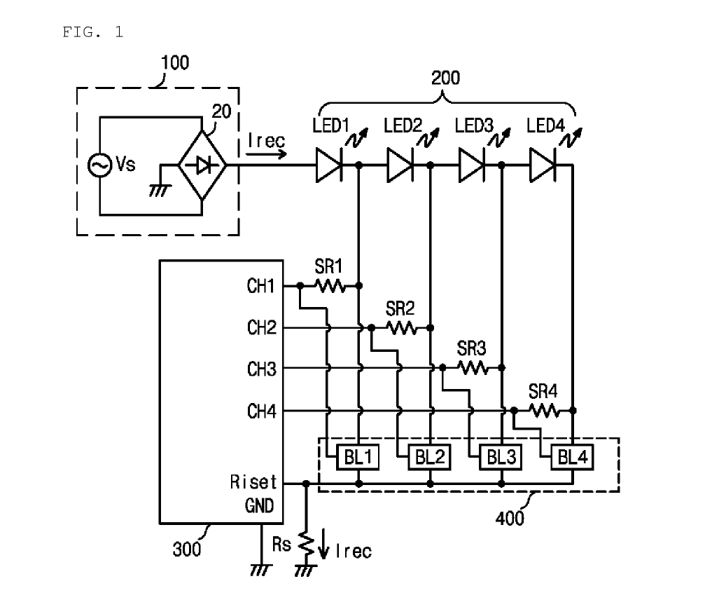

The lighting apparatus according to the present embodiment may be embodied as illustrated in FIG. 1. Referring to FIG. 1, the lighting apparatus includes a power supply unit 100, a lighting unit 200, a first driver 300, a second driver 400 and a sensing resistor Rs.

The power supply unit 100 provides a rectified voltage Vrec, and the lighting unit 200 includes LED groups which sequentially emit light in response to the rectified voltage Vrec.

The first driver 300 compares a reference voltage and a sensing voltage, sequentially provides the first current paths corresponding to light emissions of the respective LED groups of the lighting unit 200, and controls a flow of the first current in the first current path.

The second driver 400 forms a flow of the second current in the second current path in connection with the flow of the first current, the second current path being formed in parallel to the first current path in response to light emissions of part or all of the LED groups in the lighting unit 200. In FIG. 1, the second driver 400 is configured to provide the second current path in response to light emission of each of the entire LED groups.

The sensing resistor Rs is connected in parallel to the first driver 300 and the second driver 400 so as to provide a common current path, and provides a sensing voltage obtained by sensing a driving current.

More specifically, when the second current path is not formed, the sensing resistor Rs provides a sensing voltage obtained by sensing a driving current based on the first current. Furthermore, when the first current path and the second current path are formed in parallel to each other, the sensing resistor Rs provides a sensing voltage obtained by sensing a driving current of the common current path based on the first and second currents.

The second driver 400 includes a separate switching element such as FET, such that the first driver 300 is not influenced by heat generation caused by high power and the high rectified voltage Vrec.

The present embodiment discloses a configuration in which the second driver 400 is operated in connection with the first driver 300, in order to control the LED groups to emit light at power that exceeds the driving ability of the first driver 300.

The configuration and operation of the lighting apparatus in which the first driver 300 and the second driver 400 operate with each other will be described in detail.

First, the power supply unit 100 is configured to provide a rectified voltage Vrec to the lighting unit 200. For this operation, the power supply unit 100 may include an AC power supply Vs and a rectifier 20.

The AC power supply Vs may include a commercial AC power supply, and provide an AC voltage. The rectifier 20 outputs a rectified voltage Vrec obtained by full-wave rectifying the AC voltage of the AC power supply. The rectifier 20 may have a typical bridge diode structure.

The rectified voltage Vrec provided by the power supply unit 100 may have a ripple corresponding to a half cycle of the AC voltage. In the present embodiment, a change of the rectified voltage Vrec may indicate an increase/decrease of the ripple.

The lighting unit 200 emits light in response to the rectified voltage Vrec, and includes LEDs. The LEDs included in the lighting unit 200 may be divided into a plurality of LED groups. FIG. 1 illustrates the lighting unit 200 including four LED groups connected in series. That is, the lighting unit 200 includes LED groups LED1 to LED4 connected in series. The number of LED groups included in the lighting unit 200 may be set to various values, according to a designer's intention.

Each of the LED groups LED1 to LED4 included in the lighting unit 200 may include one LED or a plurality of LEDs connected in series, parallel or serial-parallel to each other.

The voltage at which an LED group emits light may be defined as a light emission voltage. More specifically, the voltage at which the LED group LED1 emits light may be defined as a light emission voltage V1 of the LED group LED1, the voltage at which the LED groups LED1 and LED2 emit light may be defined as a light emission voltage V2 of the LED group LED2, the voltage at which the LED groups LED1 to LED3 emit light may be defined as a light emission voltage V3 of the LED group LED3, and the voltage at which the LED groups LED1 to LED4 emit light may be defined as a light emission voltage V4 of the LED group LED4.

The first driver 300 performs a current regulation for light emission of the lighting unit 200, and provides the first current path for sequential light emissions of the LED groups LED1 to LED4.

More specifically, the first driver 300 may be configured to provide the first current path in response to light emissions of the LED groups LED1 to LED4 of the lighting unit 200 according to changes of the rectified voltage Vrec, and perform a current regulation on the first current of the first current path.

For this operation, the first driver 300 includes terminals CH1 to CH4, a sensing resistor terminal Riset, and a ground terminal GND. The terminals CH1 to CH4 are connected to the respective output terminals of the LED groups LED1 to LED4 included in the lighting unit 200 and form channels, and the sensing resistor terminal Riset connects the first current path to the sensing resistor Rs.

The first driver 300 uses a sensing voltage of the sensing resistor Rs, provided through the sensing resistor terminal Riset, in order to provide the first current path.

The first driver 300 compares the sensing voltage to reference voltages which are internally provided in response to the respective LED groups LED1 to LED4. According to the comparison results between the sensing voltage and the reference voltages, the first driver 300 may provide the first current path for selectively connecting the sensing resistor terminal Riset and the terminals CH1 to CH4, and control the first current of the first current path. The first currents of the first current path, which are transmitted to the respective terminals CH1 to CH4 of the first driver 300, are represented by IL1 to IL4.

The LED groups LED1 to LED4 of the lighting unit 200 sequentially emit light in response to changes of the rectified voltage Vrec which periodically rises/falls. When the rectified voltage Vrec rises, the number of LED groups emitting light increases. On the other hand, when the rectified voltage Vrec falls, the number of LED groups emitting light decreases. The first driver 300 provides the first current path which is changed in response to sequential light emissions of the lighting unit 200.

Between the terminals CH1 to CH4 of the first driver 300 and the LED groups LED1 to LED4, transmission resistors SR1 to SR4 are installed. The transmission resistors SR1 to SR4 transmit the first currents from the LED groups LED1 to LED4 to the respective terminals CH1 to CH4 of the first driver 300, and limit the first current of the first driver 300.

The second driver 400 includes blocks BL1 to BL4 which are connected to the LED groups LED1 to LED4 in parallel to the transmission resistors SR1 to SR4, respectively.

The blocks BL1 to BL4 form the second current path in response to light emissions of the LED groups LED1 to LED4. The blocks BL1 to BL4 include a switching element Q2 forming the second current path, and form a flow of the second current through the switching element Q2 in connection with the sensing of the flow of the first current inputted to the first driver 300, that is, the first current passing through the transmission resistors SR1 to SR4. The second currents of the second current paths in the blocks BL1 to BL4 are represented by IH1 to IH4.

As described above, the second current of the second driver 400 is controlled to a constant current by a feedback loop in which the first driver 300 is controlled by a sensing voltage obtained by sensing a driving current corresponding to the sum of the first and second currents.

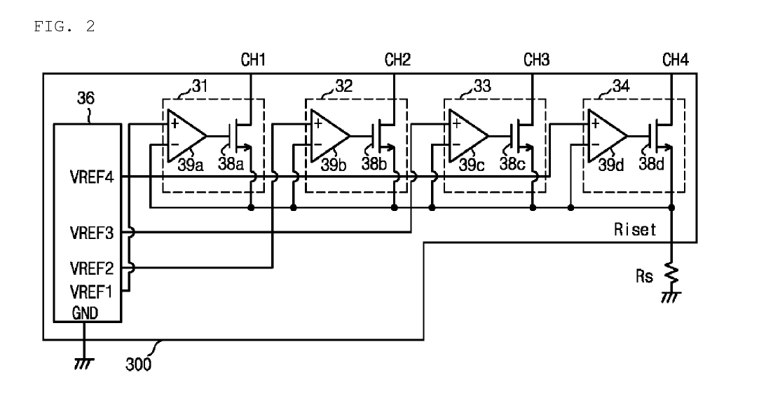

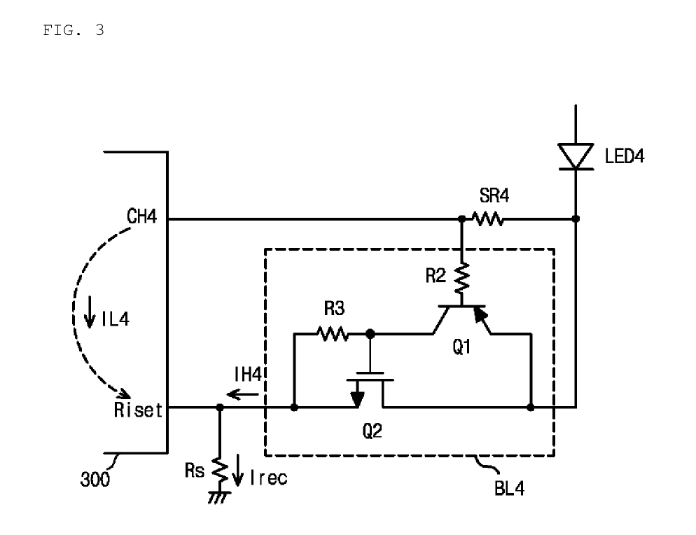

The detailed configurations and operations of the first and second drivers 300 and 400 will be described with reference to FIGS. 2 and 3.

The first and second drivers 300 and 400 are configured to form the first and second current paths in parallel to each other, in response to light emission of the same LED group. After a flow of the first current is started in the first current path of the first driver according to a change of the rectified voltage Vrec, the second driver 400 starts a flow of the second current in connection with the flow of the first current. Then, according to a change of the rectified voltage Vrec, the second driver 400 terminates the flow of the second current, and the first driver 300 then blocks the flow of the first current.

First, referring to FIG. 2, the first driver 300 includes a plurality of switching circuits 31 to 34 and a reference voltage supply unit 36. The plurality of switching circuits 31 to 34 selectively provide the first current path for the LED groups LED1 to LED4, and the reference voltage supply unit 36 provides the reference voltages VREF1 to VREF4.

The reference voltage supply unit 36 may be configured to provide the reference voltages VREF1 to VREF4 having different levels, depending on a designer's intention.

The reference voltage supply unit 36 includes a plurality of resistors connected in series, for example, and the plurality of resistors connected in series receive a constant voltage Vcc and are connected to the ground terminal GND. The reference voltage supply unit 36 may be configured to provide the reference voltages VREF1 to VREF4 having different levels to nodes between the respective resistors. Unlike the above-described configuration, the reference voltage supply unit 36 may include independent voltage supply sources for providing the reference voltages VREF1 to VREF4 having different levels.

Among the reference voltages VREF1 to VREF4 having different levels, the reference voltage VREF1 may have the lowest voltage level, and the reference voltage VREF4 may have the highest voltage. The voltage level may gradually increase in order of VREF1 to VREF4.

The reference voltage VREF1 has a level for turning off the switching circuit 31 at a point of time that the LED group LED2 emits light. More specifically, the reference voltage VREF1 may be set to a lower level than a sensing voltage formed in the sensing resistor Rs at a point of time that the LED group LED2 emits light.

The reference voltage VREF2 has a level for turning off the switching circuit 32 at a point of time that the LED group LED3 emits light. More specifically, the reference voltage VREF2 may be set to a lower level than a sensing voltage formed in the sensing resistor Rs at a point of time that the LED group LED3 emits light.

The reference voltage VREF3 has a level for turning off the switching circuit 33 at a point of time that the LED group LED4 emits light. More specifically, the reference voltage VREF3 may be set to a lower level than a sensing voltage formed in the sensing resistor Rs at a point of time that the LED group LED4 emits light.

The reference voltage VREF4 may be set in the upper limit level region of the rectified voltage Vrec, such that a current flowing through the sensing resistor Rs becomes a constant current.

The switching circuits 31 to 34 are connected to the sensing resistor Rs in common, in order to perform the current regulation and current path formation.

The switching circuits 31 to 34 compare the sensing voltage of the sensing resistor Rs to the reference voltages VREF1 to VREF4 of the reference voltage supply unit 36, and form the first current path for light emission of the lighting unit 200.

Each of the switching circuits 31 to 34 receives a high-level reference voltage as the switching circuit is connected to an LED group remote from the location where the rectified voltage Vrec is applied.

The switching circuits 31 to 34 include comparators 39a to 39d and switching elements, respectively. The switching elements may include NMOS transistors 38a to 38d.

Each of the comparators 39a to 39d of the respective switching circuits 31 to 34 has a positive input terminal (+) configured to receive a reference voltage, a negative input terminal (−) configured to receive a sensing voltage, and an output terminal configured to output a comparison result between the reference voltage and the sensing voltage.

The NMOS transistors 38a to 38d of the switching circuits 31 to 34 perform a switching operation according to the outputs of the respective comparators 39a to 39d, applied to the gates thereof. The drains of the respective NMOS transistors 38a to 38d and the negative input terminals (−) of the respective comparators 39a to 39d are connected to the sensing resistor Rs in common.

According to the above-described configuration, the sensing resistor Rs may apply the sensing voltage to the input terminals (−) of the respective comparators 39a to 39d, and provide current paths corresponding to the NMOS transistors 38a to 38d of the respective switching circuits 31 to 34.

When the level of the rectified voltage Vrec is lower than the light emission voltage of the LED group connected to each of the NMOS transistors 38a to 38d serving as the switching elements of the respective switching circuits 31 to 34, the NMOS transistor maintains a normal turn-on state because the reference voltage is higher than the sensing voltage.

In the above-described lighting apparatus, the LED groups LED1 to LED4 may sequentially emit light in response to changes of the rectified voltage Vrec, and the first current path corresponding to the sequential light emissions of the LED groups LED1 to LED4 may be provided through the first driver 300.

The configuration in which the first driver 300 of FIG. 2 changes the first current path in response to a change of the rectified voltage Vrec and regulates the first current on the first current path will be described as follows.

When the rectified voltage Vrec is in the initial state, the switching circuits 31 to 34 of the first driver 300 all maintain a turn-on state, because the reference voltages VREF1 to VREF4 applied to the positive input terminals (+) are higher than the sensing voltage across the sensing resistor Rs, the sensing voltage being applied to the negative input terminals (−). At this time, since the level of the rectified voltage Vrec is not enough for the LED groups LED1 to LED4 to emit light, the LED groups LED1 to LED4 do not emit light.

Then, when the rectified voltage Vrec rises to the light emission voltage V1, the LED group LED1 emits light. When the LED group LED1 of the lighting unit 200 emits light, the switching circuit 31 of the first driver 300 connected to the LED group LED1 provides the first current path for light emission. At this time, the first current IL1 flows through the switching circuit 31 of the first driver 300.

While the rectified voltage Vrec rises from the light emission voltage V1 to the light emission voltage V2, the first current IL1 flowing through the switching circuit 31 is retained as a constant current by the feedback sensing voltage.

Then, when the rectified voltage Vrec rises to the light emission voltage V2, the LED group LED2 emits light. When the LED group LED2 emits light, the switching circuit 32 of the first driver 300 connected to the LED group LED2 provides the first current path for light emission. At this time, the first current IL2 flows through the switching circuit 32 of the first driver 300.

When the rectified voltage Vrec reaches the light emission voltage V2 such that the LED group LED2 emits light and the first current path is formed through the switching circuit 32 of the first driver 300, the level of the sensing voltage of the sensing resistor Rs rises. At this time, the level of the sensing voltage is higher tan the reference voltage VREF1. Thus, the NMOS transistor 38a of the switching circuit 31 is turned off by an output of the comparator 39a. That is, the first current path formed by the switching circuit 31 is blocked, and the flow of the first current IL1 is terminated.

While the rectified voltage Vrec rises from the light emission voltage V2 to the light emission voltage V3, the first current IL2 flowing through the switching circuit 32 is retained as a constant current by the feedback sensing voltage.

Then, when the rectified voltage Vrec continuously rises to the light emission voltage V3, the LED group LED3 emits light. When the LED group LED3 emits light, the switching circuit 33 of the first driver 300 connected to the LED group LED3 provides the first current path for light emission. At this time, the first current IL3 flows through the switching circuit 33 of the first driver 300.

When the rectified voltage Vrec reaches the light emission voltage V3 such that the LED group LED3 emits light and the first current path is formed through the switching circuit 33 of the first driver 300, the level of the sensing voltage of the sensing resistor Rs rises. At this time, the level of the sensing voltage is higher tan the reference voltage VREF2. Thus, the NMOS transistor 38b of the switching circuit 32 of the first driver 300 is turned off by an output of the comparator 39a. That is, the first current path formed by the switching circuit 32 is blocked, and the flow of first current IL2 is terminated.

While the rectified voltage Vrec rises from the light emission voltage V3 to the light emission voltage V4, the first current IL3 flowing through the switching circuit 33 is retained as a constant current by the feedback sensing voltage.

Then, when the rectified voltage Vrec continuously rises to the light emission voltage V4, the LED group LED4 emits light. When the LED group LED4 emits light, the switching circuit 34 of the first driver 300 connected to the LED group LED4 provides the first current path for light emission. At this time, the first current IL4 flows through the switching circuit 34 of the first driver 300.

When the rectified voltage Vrec reaches the light emission voltage V4 such that the LED group LED4 emits light and the first current path is formed through the switching circuit 34 of the first driver 300, the level of the sensing voltage of the sensing resistor Rs rises. At this time, the level of the sensing voltage is higher tan the reference voltage VREF3. Thus, the NMOS transistor 38c of the switching circuit 33 of the first driver 300 is turned off by an output of the comparator 39a. That is, the first current path formed by the switching circuit 33 is blocked, and the flow of the first current IL3 is terminated.

While the rectified voltage Vrec rises from the light emission voltage V4 to the maximum voltage, the first current IL4 flowing through the switching circuit 34 is retained as a constant current by the feedback sensing voltage.

The light emission of the LED group LED4 is maintained until the rectified voltage Vrec falls to the light emission voltage V4 after rising to the maximum voltage.

Then, when the rectified voltage Vrec falls, the switching circuits 34 to 31 connected to the LED groups LED4 to LED1 are sequentially turned off, the LED groups LED4 to LED1 are sequentially turned off, and the first driver 300 provides the first current path which is changed according to the order in which the LED groups LED4 to LED1 are turned off.

The configuration of the second driver 400 will be described with reference to FIG. 3.

The second driver 400 includes blocks BL1 to BL4 which are connected to the LED groups LED1 to LED4 and sense the first current flows of the respective transmission resistors SR1 to SR4. The blocks BL1 to BL4 for the respective LED groups are configured in the same manner. FIG. 3 representatively illustrates the block BL4 connected to the LED group LED4. Since the blocks BL1 to BL3 connected in parallel to the other LED groups LED1 to LED3 are configured in the same manner as FIG. 3, the duplicated descriptions thereof are omitted herein.

The block BL4 is connected between the LED group LED4 and the sensing resistor Rs. The block BL4 includes the switching element Q2, and forms a second current flow through the switching element Q2 in connection with the sensing of the flow of the first current IL4 of the transmission resistor SR4.

For this operation, the block BL4 includes a switching control circuit and the switching element Q2. The switching control circuit may include a resistor R2, a PNP bipolar transistor Q1 and a resistor R3 of FIG. 3.

In the switching control circuit, the resistor R2 serves to sense the first current of the transmission resistor SR4, the PNP bipolar transistor Q1 serves to provide a control voltage applied to the resistor R3 in response to the first current flow, and the resistor R3 serves to stabilize the control voltage provided to the gate of the switching element Q2.

The switching element Q2 may include an NMOS transistor. The drain of the switching element Q2 and the collector of the PNP bipolar transistor Q1 are connected in parallel to each other, and connected to the output terminal of the LED group LED4. Between the source and gate of the switching element Q2, the resistor R3 is connected.

According to the above-described configuration, the switching element Q2 is driven by a control voltage corresponding to the first current flow, forms a second current path, and forms a flow of the second current IH4 in connection with the first current flow.

The block BL4 of the second driver 400 may form the flow of the second current IH4 by amplifying the first current IL4.

The source of the switching element Q2 and the sensing resistor terminal Riset of the first driver 300 are connected in parallel to the sensing resistor Rs. As a result, the switching element of the first driver 300 forming the first current path and the switching element Q2 of the block BL4 of the second driver 400 forming the second current path are connected in parallel to the sensing resistor Rs.

Thus, the sensing resistor Rs provides a third current path which the first current path of the first driver 300 and the second current path of the second driver 400 join, and provides a sensing voltage corresponding to the sum of the first and second currents.

As a result, the first driver 300 controls the flow of the first current IL4 in the first current path through current regulation using the sensing voltage, and the second driver 400 forms the flow of the second current IH4 in the second current path through the feedback loop in which the first driver 300 is controlled by the sensing voltage obtained through the current corresponding to the sum of the first and second currents.

The switching element for controlling the first current IL4 of the first current path may be embodied by an element for low power, and the switching element for forming the second current IH4 of the second current path may be embodied by an element for high power. The switching element for low power and the switching element for high power may be distinguished from each other, depending on a difference in maximum allowable current value therebetween. The maximum allowable current value of the switching element for the first current path may be lower than the maximum allowable current value of the switching element for the second current path. Thus, the first current is controlled to an amount equal to or less than the amount of second current.

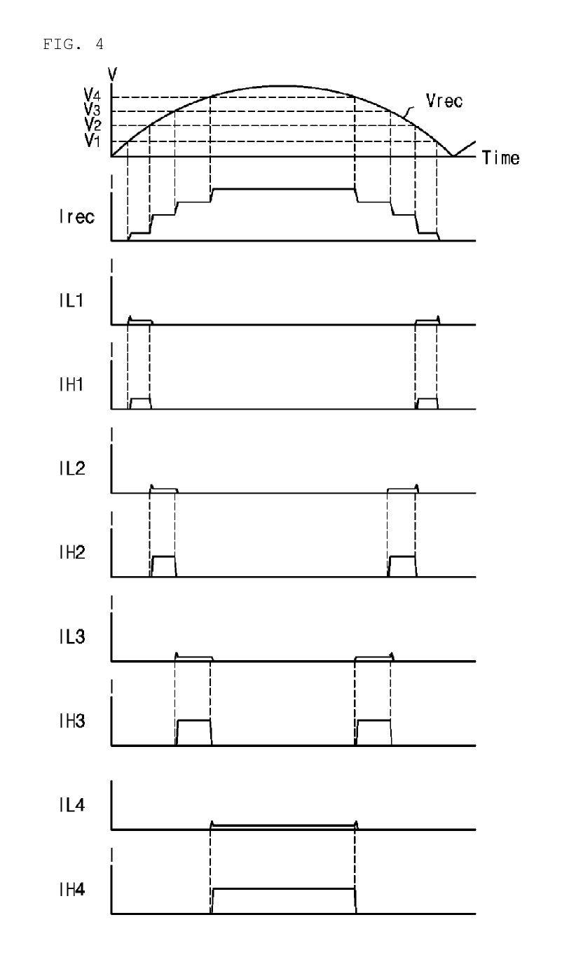

The operation of the lighting apparatus of FIGS. 1 to 3 according to the present embodiment will be described with reference to FIG. 4.

The rectified voltage Vrec repetitively rises and falls. When the rectified voltage Vrec rises, the rectified voltage Vrec rises to the maximum value equal to or higher than the light emission voltage V4. When the rectified voltage Vrec falls, the rectified voltage Vrec falls to the minimum value equal to or lower than the light emission voltage V1.

When the rectified voltage Vrec is in the initial state, the switching circuits 31 to 34 of the first driver 300 all maintain a turn-on state (normal turn-on state), and the blocks BL1 to BL4 of the second driver 400 maintain a turn-off state.

The changes of the first and second current paths and the change of the driving current Irec when the rectified voltage Vrec rises will be described.

When the rectified voltage Vrec reaches the light emission voltage V1 and only the LED group LED1 emits light, the switching circuit 31 of the first driver 300 receiving the first current IL1 first provides a first current path for light emission, and the switching element Q2 included in the block BL1 of the second driver 400 then forms a second current path. At this time, the block BL1 of the second driver 400 forms the second current path and a flow of the second current IH1 in response to the flow of the first current IL1 of the transmission resistor SR1.

When the rectified voltage Vrec reaches the light emission voltage V2 and the LED groups LED1 and LED2 emit light, the switching circuit 32 of the first driver 300 receiving the first current IL2 first provides a first current path for light emission, and the switching element Q2 included in the block BL2 of the second driver 400 then forms a second current path. At this time, the second block BL2 of the second driver 400 forms the second current path and a flow of the second current IH2 in response to the flow of the first current IL2 of the transmission resistor SR2.

The switching circuit 31 of the first driver 300, which served as the previous first current path, is turned off by the sensing voltage of which the level rises as the rectified voltage Vrec rises to the light emission voltage V2 as described with reference to FIG. 2. In connection with the process, the switching element Q2 of the block BL1 of the second driver 400, which provided the previous second current path, is also turned off. That is, when the rectified voltage Vrec reaches the light emission voltage V2, the first current path is changed to the switching circuit 32 from the switching circuit 31 of the first driver 300, and the second current path is changed to the block BL2 from the block BL1 of the second driver 400.

When the rectified voltage Vrec reaches the light emission voltage V3 and the LED groups LED1 to LED3 emit light, the switching circuit 33 of the first driver 300 receiving the first current IL3 first provides a first current path for light emission, and the switching element Q2 included in the block BL3 of the second driver 400 then forms a second current path. At this time, the block BL3 of the second driver 400 forms the second current path and a flow of the second current IH3 in response to the flow of the first current IL3 of the transmission resistor SR3.

The switching circuit 32 of the first driver 300, which served as the previous first current path, is turned off by the sensing voltage of which the level rises as the rectified voltage Vrec rises to the light emission voltage V3 as described with reference to FIG. 2. In connection with this process, the switching element Q2 of the block BL2 of the second driver 400, which provided the previous second current path, is also turned off. That is, when the rectified voltage Vrec reaches the light emission voltage V3, the first current path is changed to the switching circuit 33 from the switching circuit 32 of the first driver 300, and the second current path is changed to the block BL3 from the block BL2 of the second driver 400. When the rectified voltage Vrec reaches the light emission voltage V4 and the LED groups LED1 to LED4 emit light, the switching circuit 34 of the first driver 300 receiving the first current IL4 first provides a first current path for light emission, and the switching element Q2 included in the block BL4 of the second driver 400 then forms a second current path. At this time, the block BL4 of the second driver 400 forms the second current path and a flow of the second current IH4 in response to the flow of the first current IL4 of the transmission resistor SR4.

The switching circuit 33 of the first driver 300, which served as the previous first current path, is turned off by the sensing voltage of which the level rises as the rectified voltage Vrec rises to the light emission voltage V4 as described with reference to FIG. 2. In connection with this process, the switching element Q2 of the block BL3 of the second driver 400, which provided the previous second current path, is also turned off. That is, when the rectified voltage Vrec reaches the light emission voltage V4, the first current path is changed to the switching circuit 34 from the switching circuit 33 of the first driver 300, and the second current path is changed to the block BL4 from the block BL3 of the second driver 400.

The changes of the current paths at the points of time that the rectified voltage Vrec reaches the light emission voltages V1 to V4 will be described in detail with reference to FIG. 3. Specifically, the case in which the rectified voltage Vrec reaches the light emission voltage V4 and the LED groups LED1 to LED4 emit light will be exemplified.

When the rectified voltage Vrec reaches the light emission voltage V4 such that the LED group LED4 emits light and the first current path is formed through the switching circuit of the first driver 300, the first current IL4 flows to the sensing resistor Rs through the transmission resistor SR4 and the switching circuit 34 of the first driver 300.

When the first current IL4 flows through the transmission resistor SR4, the block BL4 senses the first current IL4. When the flow of the first current IL4 is started, the current flowing through the PNP bipolar transistor Q1 of the block BL4 is transmitted to the resistor R3. When the control voltage applied to the resistor R3 rises over the threshold voltage of the switching element Q2, the second current path is formed by the switching element Q2.

When the rectified voltage Vrec reaches a level obtained by adding the light emission voltage V4 and the threshold voltage of the switching element Q2, the block BL4 forms the second current path in connection with the flow of the first current IL4, and forms a flow of the second current IH4 in the second current path.

The first current IL4 may have a peak waveform which temporarily rises at the initial stage. However, when the second current IH4 flows, the first current IL4 is limited by the transmission resistor SR4, and the driving current Irec is retained at a constant level through current regulation using the sensing voltage of the first driver 300.

While the first current path is formed through the switching circuit 34 of the first driver 300 and the second current path is formed by the block BL4 of the second driver 400 when the rectified voltage Vrec reaches the light emission voltage V4, the block BL3 of the second driver 400, which served as the previous second current path, is turned off, and the switching circuit 33 of the first driver 300, which served as the previous first current path, is also turned off.

The case in which the rectified voltage Vrec reaches the light emission voltage V4 while the previous first and second current paths are blocked by the rise of the rectified voltage Vrec will be exemplified and described in detail.

When the rectified voltage Vrec reaches the light emission voltage V4, the level of the sensing voltage of the sensing resistor Rs is raised by the first current IL4 of the switching circuit 34 of the first driver 300 and the second current IH4 of the block BL4 of the second driver 400. At this time, the level of the sensing voltage is higher tan the reference voltage VREF3. Thus, the NMOS transistor 38c of the switching circuit 33 is turned off by an output of the comparator 39a. That is, the switching circuit 33 is turned off, and the switching circuit 34 provides the first current path corresponding to light emission of the LED group LED4.

While the first current path of the first driver 300 is changed from the switching circuit 33 to the switching circuit 34, or the flow of the first current IL1 through the switching circuit 33 is terminated, the switching element Q2 of the block BL3 of the second driver 400 is turned off before the switching circuit 33. That is, the second current IH3 of the block BL3 of the second driver 400 is first blocked, and the first current IL3 of the switching circuit 33 of the first driver 300 is then blocked.

More specifically, when the sensing voltage of the sensing resistor Rs rises as the rectified voltage Vrec reaches the light emission voltage V4, the first current IL3 of the switching circuit 33 decreases. When the first current IL3 decreases to the level which the threshold voltage of the switching element Q3 of the block BL3 in the second driver 400 is difficult to retain, the current flowing through the PNP bipolar transistor Q1 of the block BL3 decreases, and the control voltage applied to the resistor R3 of the block BL3 falls below the threshold voltage of the switching element Q2. As a result, the block BL3 of the second driver 400 blocks the formation of the second current path through the switching element Q2 and the flow of the second current IH3.

After a predetermined time has elapsed from a point of time that the formation of the second current path and the flow of the second current IH3 were blocked by the block BL3 of the second driver 400, the first current IL3 of the switching circuit 33 of the first driver 300 is blocked.

When the rectified voltage Vrec rises between the light emission voltages, the first current path by the first driver 300 and the second current path by the second driver 400 are formed in parallel to each other.

More specifically, the first current path of the first driver 300 and the second current path of the second driver 400 are formed in parallel to each other, in response to the rising section of the rectified voltage Vrec, which is classified into the section from the light emission voltage V1 to the light emission voltage V2, the section from the light emission voltage V2 to the light emission voltage V3, the section from the light emission voltage V3 to the light emission voltage V4 and the section from the light emission voltage V4 to the maximum voltage.

At this time, the sensing resistor Rs provides the third current path which the first and second current paths join, and provides the sensing voltage corresponding to the driving current Irec obtained by adding the first and second currents.

The first current of the first driver 300 is limited by the transmission resistor, the second current of the second driver 400 is started in connection with the increase of the first current, and the driving current Irec obtained by adding the first and second currents is controlled to a constant current by the feedback loop that feeds back the sensing voltage to the first driver 300.

In the above-described configuration, the driving current Irec has a waveform that increases in a stepwise manner according to sequential emissions, in response to the rectified voltage Vrec that rises as illustrated in FIG. 4. Furthermore, the second currents IH1 to IH4 are formed after the first currents IL1 to IL4 are formed, respectively, and the first currents IL1 to IL4 are blocked after the second currents IH1 to IH4 are blocked, respectively.

Hereafter, the changes of the first and second current paths and the change of the driving current Irec when the rectified voltage Vrec falls will be described.

When the rectified voltage Vrec falls, the LED groups LED4 to LED1 are sequentially turned off, the first driver 300 provides the first current path which is changed according to the order in which the LED groups LED4 to LED1 are turned off, and the second current path is also changed in response to the change of the first current path.

Specifically, when the rectified voltage Vrec retains the light emission voltage V4 or more, the first current path formed by the switching circuit 34 of the first driver 300 receiving the first current IL4 through the transmission resistor SR4 of the second driver 400 and the second current path formed by the switching element Q2 included in the block BL4 of the second driver 400 are formed in parallel to each other.

In this state, when the rectified voltage Vrec falls below the light emission voltage V4, the first current path is changed to the switching circuit 33 of the first driver 300, and the second current path is changed to the switching element Q2 included in the block BL3 of the second driver 400.

At this time, the second current path by the block BL4 of the second driver 400 is blocked before the first current path by the switching circuit 34 of the first driver 300. Furthermore, the first current path by the switching circuit 33 of the first driver 300 is formed before the second current path by the block BL3 of the second driver 400.

Then, the changes of the first and second current paths by the falls of the rectified voltage Vrec are performed in the same manner as described above. Thus, the detailed descriptions thereof are omitted herein.

As a result, the driving current Irec has a waveform that decreases in a stepwise manner according to the sequential turns-off, in response to the rectified voltage Vrec that falls as illustrated in FIG. 4. Furthermore, the second currents IH1 to IH4 are formed after the first currents IL1 to IL4 are formed, respectively, and the first currents IL1 to IL4 are blocked after the second currents IH1 to IH4 are blocked, respectively.

The lighting apparatus according to the embodiment of FIGS. 1 to 4 has a configuration for providing the first and second current paths to all of the LED groups LED1 to LED4 of the lighting unit 200.

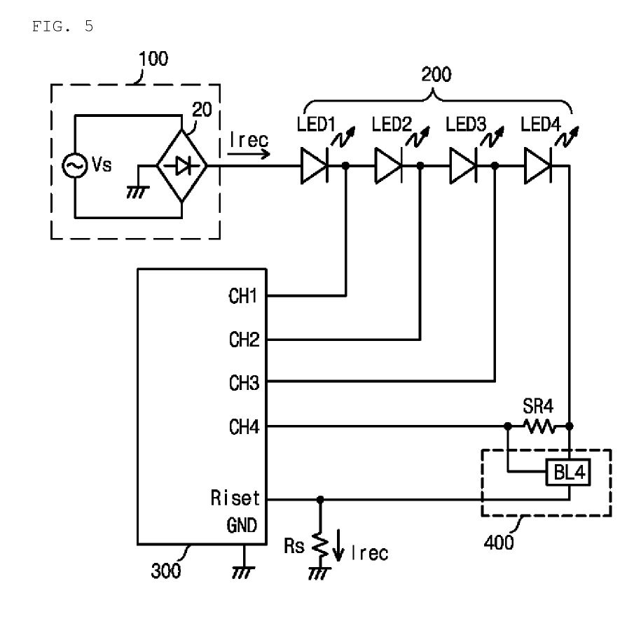

Depending on a designer's intention, however, the lighting apparatus may be configured to provide the first and second current paths only to a part of the LED groups as illustrated in FIG. 5. In this case, the LED groups to which the first and second current paths are provided may be selected in various manners. Since the configuration and operation of the embodiment of FIG. 5 can be understood through the descriptions of the embodiment of FIGS. 1 to 4, the duplicated descriptions are omitted herein.

In the embodiment of FIG. 5, only a first current path is formed in response to light emissions of the LED groups LED1 to LED3, and first and second current paths are formed in response to light emission of the LED group LED4.

In the embodiment of FIG. 5, when the second current path is not formed, the sensing resistor Rs provides a sensing voltage to the switching circuits 31 to 33 of the first driver, the sensing voltage obtained by sensing the driving current of the first current path. On the other hand, when the first and second current paths are formed in parallel to each other, the sensing resistor Rs provides a third current path which the first and second current paths join, and provides a sensing voltage to the switching circuit 34 of the first driver 300, the sensing voltage being obtained by sensing a driving current of the third current path.

Thus, the light apparatus according to the embodiments of FIGS. 1 to 5 can provide the second current path for the second current corresponding to high power to the second driver 400 configured separately from the first driver 300, and form the second current path in connection with the first current path corresponding to low power. Therefore, the lighting apparatus can stably form the second current path for the second current corresponding to a high rectified voltage. Thus, the first driver 300 can reduce an influence by heat generation.

The lighting apparatus according to the present embodiment can provide the first current path for the first current corresponding to low power and the second current path for the second current corresponding to high power, in parallel to each other. Furthermore, the lighting apparatus can stably form the second current flow in connection with the first current flow, and minimize an influence on the chip by heat generation.

The first current path and the second current path may be separately implemented. For this configuration, the first current path may be connected to a sensing resistor, and the second current path may be connected to a load or additional sensing resistor.

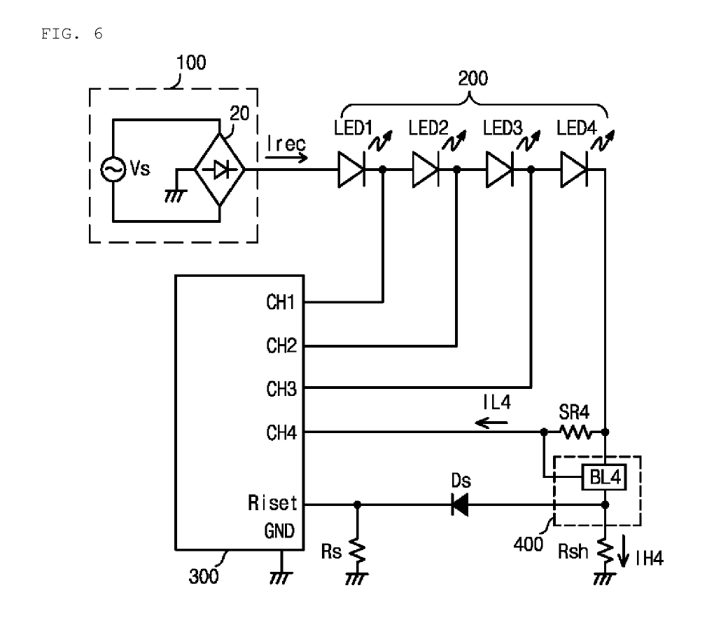

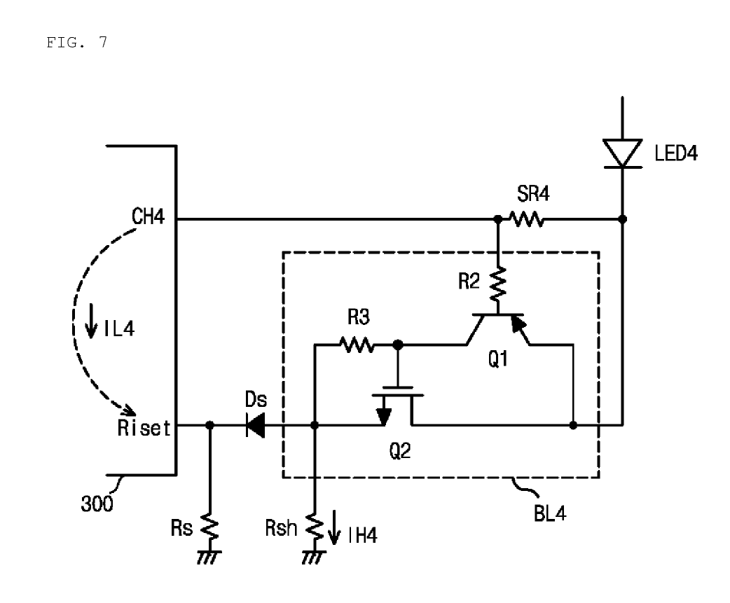

FIGS. 6 and 7 illustrate an embodiment for such a configuration.

The lighting apparatus according to the embodiment of FIGS. 6 and 7 may further include a load Rsh for a second current outputted from the second driver 400, and a voltage generated by the load Rsh may be transmitted to the sensing resistor Rs. That is, the sensing resistor Rs may provide a third current path which the first current of the first current path and a part of the second current of the second current path join, and provide a sensing voltage obtained by sensing a driving current of the third current path. At this time, the load Rsh includes a resistor, and provides a path for the other part of the second current of the second current path.

The lighting apparatus according to the embodiment of FIGS. 6 and 7 includes a diode Ds, a resistor (not illustrated) or a circuit (not illustrated) in which a diode and resistor are combined, between the sensing resistor Rs and the load Rsh, in order to transmit the voltage generated by the load Rsh to the sensing resistor Rs. The diode Ds induces a current flow toward the sensing resistor Rs.

Since the components of FIGS. 6 and 7 excluding the sensing resistor Rs, the load Rsh and the diode Ds are configured in the same manner as those of FIGS. 1 and 3, the duplicated descriptions thereof are omitted herein.

In the embodiment of FIGS. 6 and 7, the first driver 300 uses a lower feedback voltage than in the embodiment of FIGS. 1 and 3. Thus, the first driver 300 may have an advantage in that it can provide a first current path and perform current regulation in a low voltage environment.

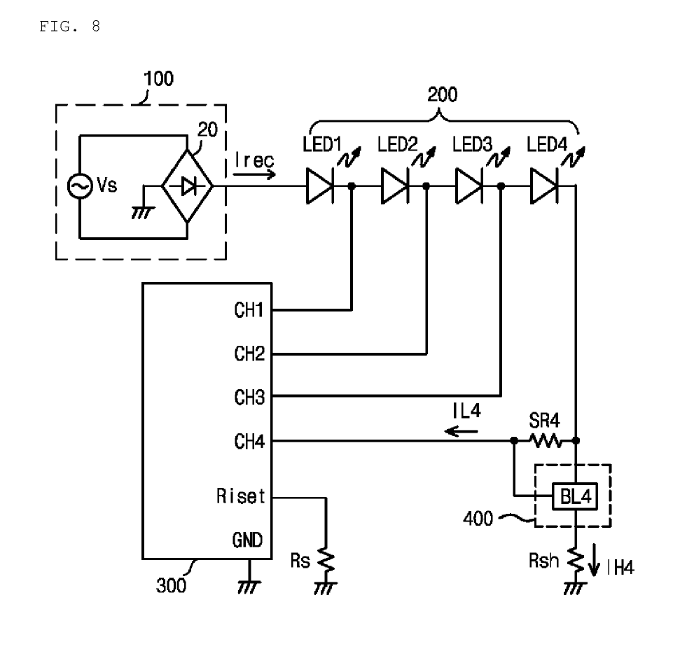

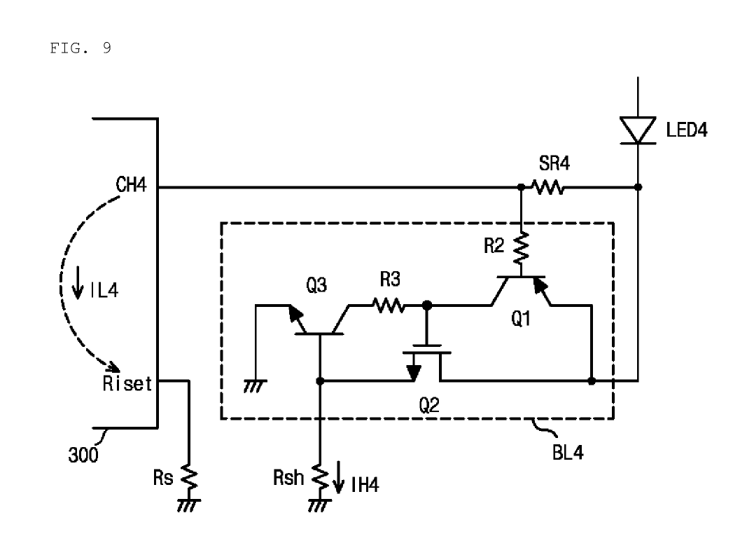

The lighting apparatus according to the present embodiment may further include a separate sensing resistor Rsh as illustrated in FIGS. 8 and 9. The sensing resistor Rs and the sensing resistor Rsh may be independently implemented.

In this case, the sensing resistor Rs provides a sensing voltage obtained by sensing the first current of the first current path, and the sensing resistor Rsh controls a flow of the second current of the second current path.

At this time, a block of the second driver 400 forming the second current path needs to have a current regulation function for the second current. That is, the block of the second driver 400 may be configured to regulate the second current flow using the sensing voltage of the sensing resistor Rsh.

In order to implement the above-described current regulation, a block BL4 of FIG. 9 is exemplified. Since the other components of FIG. 9 are configured in the same manner as the above-described embodiments, the duplicated descriptions are omitted herein.

The block BL4 of FIG. 9 further includes an NPN bipolar transistor Q3, the base of the NPN bipolar transistor Q3 and the source of the switching element Q2 are connected to the sensing resistor Rsh in common, the collector of the NPN bipolar transistor Q3 and the gate of the switching element Q2 are connected through the resistor R3, and the emitter of the NPN bipolar transistor Q3 is grounded.

According to the above-described configuration, the second current IH4 flowing to the sensing resistor Rsh through the switching element Q2 of the block BL4 is sensed by the NPN bipolar transistor Q3, and the NPN bipolar transistor Q3 changes the gate potential of the switching element Q2 in response to a change of the second current IH4.

According to the above-described configuration, the lighting apparatus according to the embodiment of FIGS. 8 and 9 performs current regulation through the first driver 300 in response to the first current, and performs current regulation through the block BL4 in response to the second current.

Thus, the lighting apparatus can form a current path for a current corresponding to high power, and control a current of a current path corresponding to low power or regulate a current of the current path corresponding to high power, thereby guaranteeing a stable current flow for light emission.

According to the embodiments of the present invention, the lighting apparatus can provide a current path for a current corresponding to high power to the outside of the driving circuit (driver) embodied by a chip, thereby removing heat generation caused by high power.

Furthermore, the lighting apparatus can provide the current path for the first current corresponding to low power and the current path for the second current corresponding to high power, and stably form the second current flow in connection with the first current flow.

Furthermore, the lighting apparatus can form a current path for a current corresponding to high power, and control a current of a current path corresponding to low power or regulate the current of the current path corresponding to high power, thereby guaranteeing a stable current flow for light emission.

While various embodiments have been described above, it will be understood to those skilled in the art that the embodiments described are by way of example only. Accordingly, the disclosure described herein should not be limited based on the described embodiments.

What is claimed is:

1. A lighting apparatus comprising:
an LED group configured to emit light in response to a rectified voltage;
a first driver comprising a first switching element, and configured to control a flow of a first current through the first switching element, the first current being outputted from the LED group emitting light;
a second driver comprising a second switching element, and configured to control a flow of a second current through the second switching element in connection with the flow of the first current of the first driver, the second current being outputted from the LED group emitting light; and
a sensing resistor configured to provide a common current path for the first and second currents, and provide a sensing voltage obtained by sensing a driving current flowing through the common current path,
wherein the first driver controls the flow of the first current by comparing a reference voltage and the sensing voltage.

2. The lighting apparatus of claim 1, wherein after the first switching element is turned on to start a flow of the driving current, the second switching element is turned on in connection with the flow of the first current, and
after the second switching element is turned off, the first switching element is turned off to terminate the flow of the driving current.

3. The lighting apparatus of claim 1, wherein the first driver comprises:
a reference voltage supply unit configured to provide the reference voltage;
a comparison unit configured to compare the reference voltage and the sensing voltage; and
a first switching element configured to regulate the flow of the first current according to an output of the comparison unit,
wherein the first switching element maintains a normal turn-on state, and is turned off when the sensing voltage is higher than the reference voltage.

4. The lighting apparatus of claim 1, wherein the second driver comprises a second switching element, and forms the flow of the second current through the second switching element by sensing the first current inputted to the first driver.

5. The lighting apparatus of claim 4, further comprising a transmission resistor configured to transmit the first current from the LED group to the first driver,
wherein the second driver senses the flow of the first current passing through the transmission resistor.

6. The lighting apparatus of claim 4, wherein the second driver comprises:
a switching control circuit configured to form a control voltage corresponding to the amount of first current; and
a second switching element configured to control the flow of the second current in response to the level of the control voltage.

7. The lighting apparatus of claim 1, further comprising a load for the flow of the second current outputted from the second driver,
wherein a voltage generated in the load is transmitted to the sensing resistor.

8. The lighting apparatus of claim 7, wherein the voltage generated in the load is transmitted to the sensing resistor through one or more of a resistor and diode.

9. A lighting apparatus comprising:
a lighting unit comprising LED groups that sequentially emit light in response to a rectified voltage;
a first driver configured to compare a reference voltage and a sensing voltage, sequentially provide a first current path corresponding to light emissions of the LED groups, and control a flow of a first current in the first current path;
a second driver configured to provide a second current path in parallel to the first current path to a specific LED group in which the first current path is formed, among the LED groups, and form a flow of a second current in the second current path in connection with the flow of the first current; and
a sensing resistor configured to provide a common current path for the first and second currents, and provide a sensing voltage obtained by sensing a driving current flowing through the common current path,
wherein the first driver controls the flow of the first current by comparing the reference voltage and the sensing voltage.

10. The lighting apparatus of claim 9, wherein the sensing resistor provides the sensing voltage obtained by sensing the driving current based on the first current when the second current path is not formed, and provides the sensing voltage obtained by sensing the driving current corresponding to the sum of the first and second currents when the first current path and the second current path are formed in parallel to each other.

11. The lighting apparatus of claim 9, wherein when the first current path by the first driver and the second current path by the second driver are formed in parallel to each other in response to light emission of the same LED group,
the second driver starts the flow of the second current in connection with the flow of the first current after the flow of the first current is started in the first current path, and
the first driver blocks the flow of the first current after the second driver terminates the flow of the second current.

12. The lighting apparatus of claim 9, wherein the first driver comprises:
a reference voltage supply unit configured to provide the reference voltage;
a comparison unit configured to compare the reference voltage and the sensing voltage; and
a first switching element configured to provide the first current path according to an output of the comparison unit, and control the flow of the first current,
wherein the first switching element maintains a normal turn-on state, and is turned off when the sensing voltage is higher than the reference voltage.

13. The lighting apparatus of claim 9, wherein the second driver comprises one or more blocks implemented for part or all of the LED groups, and
the block comprises a switching element configured to form the second current path, and forms the flow of the second current through the switching element in connection with the sensing of the flow of the first current inputted to the first driver.

14. The lighting apparatus of claim 13, further comprising one or more transmission resistors implemented for part or all of the LED groups, and configured to transmit the first current to the first driver,
wherein each of the one or more blocks senses the flow of the first current passing through the transmission resistor corresponding to the block.

15. The lighting apparatus of claim 13, wherein the block comprises:
a switching control circuit configured to form a control voltage corresponding to the amount of first current; and
the switching element configured to control the formation of the second current path and the flow of the second current, in response to the level of the control voltage.

16. The lighting apparatus of claim 9, wherein the first current is controlled to an amount equal to or less than the amount of second current.

17. A lighting apparatus comprising:
a lighting unit comprising LED groups that sequentially emit light in response to a rectified voltage;
a first driver configured to compare a reference voltage and a first sensing voltage, sequentially provide a first current path corresponding to light emissions of the LED groups, and control a flow of a first current in the first current path;
a second driver configured to provide a second current path in parallel to the first current path to a specific LED group in which the first current path is formed, among the LED groups, and form a flow of a second current in the second current path in connection with the flow of the first current;
a first sensing resistor configured to provide a first sensing voltage obtained by sensing the first current of the first current path; and
a second sensing resistor through which the second current of the second current path flows.

18. The lighting apparatus of claim 17, wherein the second driver regulates the flow of the second current using a second sensing voltage of the second sensing resistor.
